(19) United States
(12) Patent Application Publication
(10) Pub. No.: US 2014/0247105 A1
(43) Pub. Date: Sep. 4, 2014

(54) ELECTRONIC COMPONENT

(71) Applicant: MURATA MANUFACTURING CO., LTD., Kyoto (JP)

(72) Inventors: Ryota HASHIMOTO, Kyoto (JP); Kazunobu SHIMOE, Kyoto (JP)

(73) Assignee: MURATA MANUFACTURING CO., LTD., Kyoto (JP)

(21) Appl. No.: 14/151,738

(22) Filed: Jan. 9, 2014

(30) Foreign Application Priority Data
Mar. 1, 2013 (JP) 2013-040587

(51) Int. Cl. H01F 27/24

(52) U.S. Cl. CPC H01F 27/24
USPC 336/221

(57) ABSTRACT

An electronic component having a core including a winding base extending in an axial direction. A first flange is located at an end in the axial direction and having at least one first protruded side surface, which is protruded from the winding base, at least at an end in a first direction, which is one of perpendicular directions that are perpendicular to the axial direction. A wire is wound around the winding base. A first external electrode is connected to the wire and is provided on a side surface of the first flange located at an end in one of the perpendicular directions. A first outer edge of the first flange crosses the wire when viewed from the first direction has a vector having a component in the axial direction.

### CROSS REFERENCE TO RELATED APPLICATIONS

This application claims benefit of priority to Japanese Patent Application No. 2013-040587 filed Mar. 1, 2013, the entire content of which is incorporated herein by reference.

### TECHNICAL FIELD

The present disclosure relates to an electronic component, and more particularly to an electronic component such as an inductor, etc.

### BACKGROUND

As a conventional electronic component, there is known, for example, a chip coil 500 disclosed by Japanese Patent Laid-Open Publication No. 2003-17336 is shown in FIG. 7 with a perspective view. FIG. 8 is a plan view of a flange 501c and its vicinity viewed from a direction perpendicular to the axis of a winding base 501a. In FIGS. 7 and 8, the extending direction of the central axis of the winding base 501a is referred to as an x-axis direction, and a direction that is perpendicular to the x-axis direction from the central axis of the winding base 501 toward a mounting surface is referred to as a y-axis direction.

As shown by FIG. 7, the chip coil 500 comprises a core 501, a wire 502, and terminal electrodes 503a and 503b. The core 501 has a winding base 501a extending in the x-axis direction, and flanges 501b and 501c arranged at both ends of the winding base 501a. The terminal electrode 503a is provided on a surface at a positive y-axis end of the flange 501b. The terminal electrode 503b is provided on a surface at a positive y-axis end of the flange 501c. The wire 502 is wound around the winding base 501a, and both ends of the wire 502 are connected respectively to the terminal electrodes 503a and 503b.

In the chip coil 500, around the connection part between the terminal electrode 503a and the wire 502 and the connection part between the terminal electrode 503b and the wire 502, as shown by FIG. 8, the wire 502 is bent in the x-axis direction. This is to prevent the wire 502 in the connection parts from slipping off from the terminal electrodes 503a and 503b to the winding base 501a before the wire 502 is thermal-bonded to the terminal electrodes 503a and 503b. The bending of the wire 502 in the x-axis direction, however, results in formation of wire-unwound portions P501 at the ends of the winding base 501a. Thereby, in the chip coil 500, the number of turns of the wire 502 around the winding base 501a is limited, and it is difficult to achieve a desired inductance value.

### SUMMARY

An object of the present disclosure is to provide an electronic component wherein the number of turns of a wire wound around a winding base is increased.

An electronic component according to an embodiment of the present disclosure comprises: a core comprising a winding base extending in an axial direction, and a first flange located at an end in the axial direction and having at least one first protruded side surface, which is protruded from the winding base, at least at an end in a first direction, which is one of perpendicular directions that are perpendicular to the axial direction; a wire wound around the winding base; and a first external electrode that is connected to the wire and that is provided on a side surface of the first flange located at an end in one of the perpendicular directions. In the electronic component, a first outer edge of the first flange that crosses the wire when viewed from the first direction has a vector having a component in the axial direction.

### BRIEF DESCRIPTION OF THE DRAWINGS

This and other objects and features of the present disclosure will be apparent from the following description, with reference to the accompanying drawings, in which:

FIG. 1 is a perspective view of an electronic component according to a first embodiment of the present disclosure;

FIG. 2 is a plan view of the electronic component according to the first embodiment, showing a flange and its vicinity viewed from a direction perpendicular to an axial direction of a winding base;

FIG. 3 is a planview of the electronic component according to the first embodiment, showing another flange and its vicinity viewed from the direction perpendicular to the axial direction of the winding base;

FIG. 4 is a perspective view of an electronic component according to a second embodiment of the present disclosure;

FIG. 5 is a perspective view of an electronic component according to a third embodiment of the present disclosure;

FIG. 6 is a perspective view of an electronic component according to a fourth embodiment of the present disclosure;

FIG. 7 is a perspective view of a chip coil disclosed by Japanese Patent Laid-Open Publication No. 2003-17336; and

FIG. 8 is a plan view of the chip coil disclosed by Japanese Patent Laid-Open Publication No. 2003-17336, showing a flange and its vicinity viewed from a direction perpendicular to an axial direction of a winding base.

### DETAILED DESCRIPTION

Electronic components according to some embodiments of the present disclosure will be hereinafter described.

### First Embodiment

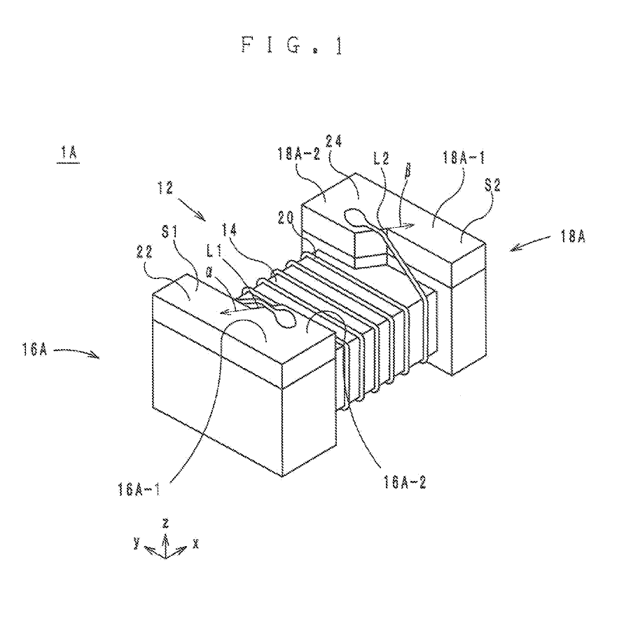

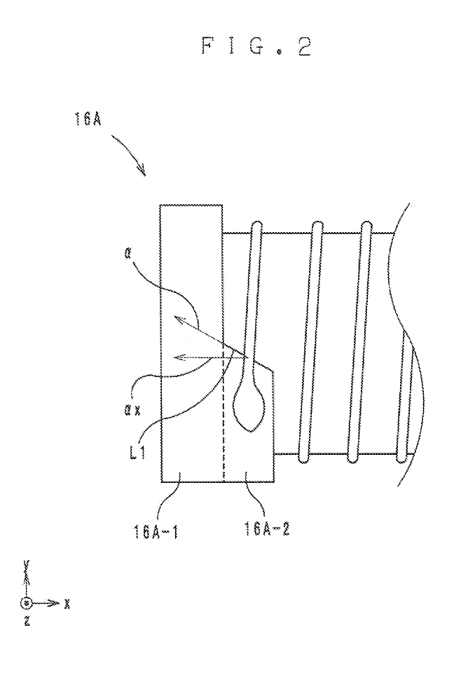

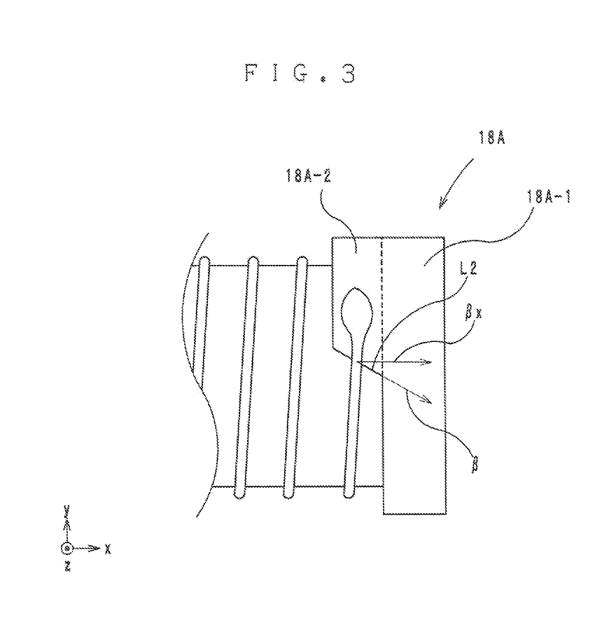

The structure of an electronic component 1A according to a first embodiment is described. FIG. 1 is a perspective view of the electronic component 1A according to the first embodiment. FIGS. 2 and 3 are plan views of the electronic component 1A, showing a flange 16A and its vicinity and another flange 18A and its vicinity, respectively, viewed from a direction perpendicular to an axial direction of a winding base 14. In FIGS. 1 to 3, a direction along the central axis of the winding base 14 is defined as an x-axis direction. In a plan view from the x-axis direction, a direction along the longer sides of the flange 16A is defined as a y-axis direction, and a direction along the shorter sides of the flange 16A is defined as a z-axis direction. The x-axis direction, the y-axis direction and the z-axis direction are perpendicular to each other.

As shown by FIG. 1, the electronic component 1A comprises a core 12, a wire 20 and external electrodes 22 and 24. The core 12 is formed from an insulating material, such as ferrite, alumina or the like. The core 12 includes the winding base 14, and the flanges 16A and 18A.

The winding base 14, as shown in FIG. 1, is a prismatic member extending in the x-axis direction. However, the winding base 14 does not need to be prismatic, and may be cylindrical or polygonal.

The flanges 16A and 18A are located at both x-axis ends of the winding base 14. Specifically, as shown in FIG. 1, the flange 16A (first flange) is located at a negative x-axis end of the winding base 14. The flange 18A (second flange) is located at a positive x-axis end of the winding base 14.

The flange 16A, as shown in FIG. 1, protrudes from the winding base 14 at least in a positive z-axis direction (in a first direction). In this embodiment, the flange 16A protrudes from the winding base 14 in both positive and negative z-axis directions and in both positive and negative y-axis directions, and accordingly, the flange 16A protrudes in all of the directions perpendicular to the x-axis. Thereby, there is formed a level difference between the flange 16A and the winding base 14.

The flange 16A has a principal part 16A-1 and an extension 16A-2. The principal part 16A-1 is in the shape of a rectangular parallelepiped and is a negative x-axis part of the flange 16A. The extension 16A-2 is a positive x-axis part of the flange 16A that extends from the negative y-axis portion of the principal part 16A-1 in the positive x-axis direction (toward the center of the winding base 14). The extension 16A-2, when viewed from the z-axis direction, is in a trapezoidal shape having a base parallel to the y-axis. In the following paragraphs, the surfaces of the flange 16A that are perpendicular to the x-axis are referred to as side surfaces, and especially, the surface at the positive z-axis end of the flange 16A is referred to as a side surface S1.

The flange 18A, as shown in FIG. 1, protrudes from the winding base 14 at least in a positive z-axis direction (in a second direction). In this embodiment, the flange 18A protrudes from the winding base 14 in both positive and negative z-axis directions and in both positive and negative y-axis directions, and accordingly, the flange 18A protrudes in all of the directions perpendicular to the x-axis. Thereby, there is formed a level difference between the flange 18A and the winding base 14.

The flange 18A has a principal part 18A-1 and an extension 18A-2. The principal part 18A-1 is in the shape of a rectangular parallelepiped and is a positive x-axis part of the flange 18. The extension 18A-2 is a negative x-axis part of the flange 18A that extends from the positive y-axis portion of the principal part 18A-1 in the negative x-axis direction (toward the center of the winding base 14). The extension 18A-2, when viewed in the z-axis direction, is in a trapezoidal shape having a base parallel to the y-axis. In the following paragraphs, the surfaces of the flange 18A that are perpendicular to the x-axis are referred to as side surfaces, and especially, the surface at the positive z-axis end of the flange 18A is referred to as a side surface S2.

The flanges 16A and 18A are symmetrical with each other with respect to a straight line in parallel to the z-axis that passes the center of the winding base 14. When the electronic component 1A is mounted on a circuit board, the surfaces of the flanges 16A and 18A at the positive z-axis end, that is, the side surfaces S1 and S2 will function as a mounting surface to be opposed to the circuit board.

The external electrode 22 (first external electrode), as shown in FIG. 1, is arranged to cover the side surface S1 of the flange 16A.

The external electrode 24 (second external electrode), as shown in FIG. 1, is arranged to cover the side surface S2 of the flange 18A. The external electrodes 22 and 24 are formed from a Ni-based alloy, such as Ni—Cr, Ni—Cu or Ni, Ag, Cu, Sn or the like.

The wire 20 is a conductive wire wound around the winding base 14. The negative x-axis end of the wire 20 is connected to the external electrode 22 on the side surface 51, and the positive x-axis end of the wire 20 is connected to the external electrode 24 on the side surface S2. The wire 20 has a core formed primarily from a conductive material such as cupper or silver, and the core is coated with an insulating material such as polyurethane.

In a plan view from the positive z-axis side, as shown by FIG. 2, the vector a of an outer edge L1 of the flange 16A that crosses the wire 20 (the vector of a first outer edge) has a component ax along the x-axis. Accordingly, the side surface S1 of the flange 16A is substantially L-shaped, and the flange 16A protrudes in the positive x-axis direction through the portion of the wire 20 that crosses over the level difference between the flange 16A and the winding base 14. It is preferred that in a plan view from the positive z-axis side, the intersection between the outer edge L1 and the wire 20 is located in the negative x-axis side of the outer edge L1. According to this embodiment, in a plan view from the positive z-axis side, the outer edge L1 is located between both y-axis ends of the flange 16A. In other words, the outer edge L1 is neither of the y-axis ends of the flange 16A.

In a plan view from the positive z-axis side, as shown by FIG. 3, the vector B of an outer edge L2 of the flange 18A that crosses the wire 20 (the vector of a second outer edge) has a component Bx along the x-axis. Accordingly, the side surface S2 of the flange 18A is substantially L-shaped, and the flange 18A protrudes in the negative x-axis direction through the portion of the wire 20 that crosses over the level difference between the flange 18A and the winding base 14. It is preferred that in a plan view from the positive z-axis side, the intersection between the outer edge L2 and the wire 20 is located in the positive x-axis side of the outer edge L2. According to the second embodiment, in a plan view from the positive x-axis side, the outer edge L2 is located between both y-axis ends of the flange 18A. In other words, the outer edge L2 is neither of the y-axis ends of the flange 18A.

### Manufacturing Method of the Electronic Component

A manufacturing method of the electronic component 1A is hereinafter described.

First, ferrite-based powder is prepared as the material of the core 12. The ferrite powder is filled in a female die, and the powder filled in the female die is pressed with a male die. Thereby, the powder is molded into the core 12 having the wiring base 14, and the flanges 16A and 18A. After the pressing process, the core 12 is sintered, whereby the core 12 is completed.

Next, the external electrodes 22 and 24 are formed on the flanges 16A and 18A, respectively, of the core 12. More specifically, in a container filled with paste of Ag or the like, the side surface S1 of the flange 16A and the side surface S2 of the flange 18A are dipped so that the Ag paste can stick to the side surfaces S1 and S2. Next, the Ag paste stuck on the side surfaces S1 and S2 is baked and dried, whereby Ag films are formed on the side surface S1 of the flange 16A and on the side surface S2 of the flange 18A as base electrodes. Further, a metal film, for example, formed from a Ni-based alloy is formed on each of the Ag films by electroplating or the like. In this way, the external electrodes 22 and 24 as shown in FIG. 1 are formed.

Next, the wire 20 is wound around the winding base 14. In this moment, both ends of a predetermined length of the wire 20 are led out from the winding base 14. The led-out portions of the wire 20 are connected to the external electrodes 22 and 24, respectively, by thermocompression bonding. Through the processes above, the electronic component 1A is completed.

### Advantageous Effects

In the electronic component 1A of the above-described structure, the number of turns of the wire 20 around the winding base 14 is increased. Specifically, as shown by FIG. 2, the vector a of the outer edge L1 of the flange 16A has a component ax in the x-axis direction. Accordingly, the side surface S1 of the flange 16A protrudes in the positive x-axis direction through the portion of the wire 20 that crosses over the level difference between the flange 16A and the winding base 14. The same applies to the flange 18A located at the other end of the winding base 14. Thus, in the electronic component 1A, it is not necessary to bend the wire 20 largely in the x-axis direction. Therefore, the electronic component 1A does not have such a problem as in the chip coil 500 that winding base 501a has wire-unwound portions P501. Hence, in the electronic component 1A, the wire 20 can be wound around the winding base 14 from one end to the other end, and the number of turns of the wire 20 can be increased.

In the electronic component 1A, since it is not necessary to bend the wire 20 largely in the x-axis direction as described above, the wire 20 is prevented from stresses caused by bends of the wire 20 at both ends.

### Second Embodiment

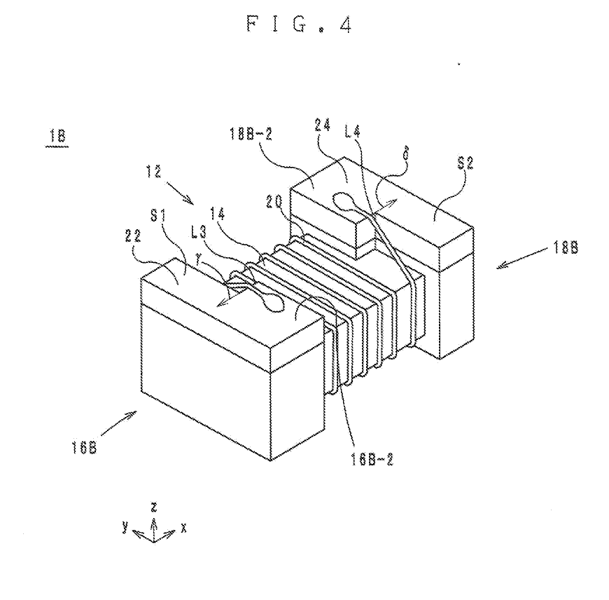

The structure of an electronic component 1B according to a second embodiment is described with reference to the accompanying drawings. FIG. 4 is a perspective view of the electronic component 1B according to the second embodiment. In FIG. 4, the x-axis, the y-axis and the z-axis are defined in the same manner as in FIG. 1.

The electronic component 1B is different from the electronic component 1A in the shapes of the flanges 16A and 18A. There is no other difference between the electronic component 1A and the electronic component 1B, and the other parts of the electronic component 1B are not described here. The flanges of the electronic component 1B are denoted by 16B and 18B. In FIG. 4, the same parts and members as provided in the electronic component 1A are denoted by the same reference marks as shown in FIG. 1.

When the electronic component 1B is viewed from the z-axis direction, an outer edge L3 of the flange 16B that crosses the wire 20 (first outer edge), as shown in FIG. 4, is parallel to the x-axis, that is, the vector y of the outer edge L3 has only a component in the x-axis direction. Accordingly, in a planview from the z-axis direction, the extension 16B-2 of the flange 16B is in the shape of a rectangle extending in the positive x-axis direction.

When the electronic component 1B is viewed from the z-axis direction, an outer edge L4 of the flange 18B that crosses the wire 20 (second outer edge), as shown in FIG. 4, is parallel to the x-axis, that is, the vector 6 of the outer edge L4 has only a component in the x-axis direction. Accordingly, in a plan view from the z-axis direction, the extension 18B-2 of the flange 18B is in the shape of a rectangle extending in the negative x-axis direction.

The electronic component 1B of the above-described structure has the same advantageous effects as described in connection with the first embodiment.

### Third Embodiment

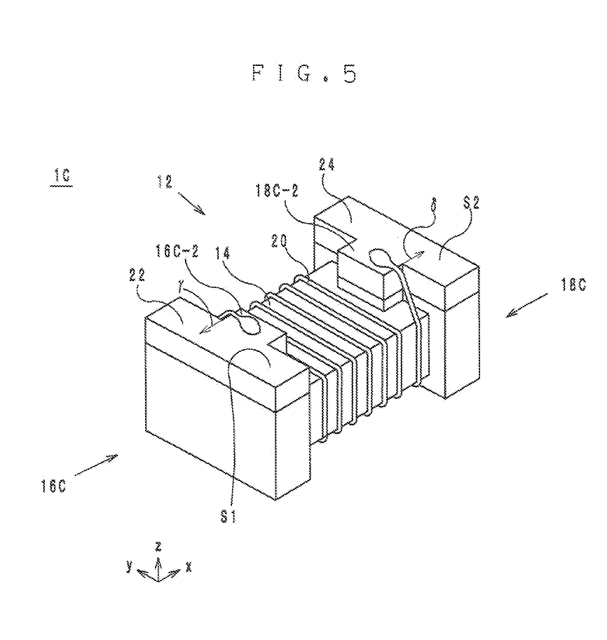

The structure of an electronic component 1C according to a third embodiment is described with reference to the accompanying drawings. FIG. 5 is a perspective view of the electronic component 1C according to the third embodiment. In FIG. 5, the x-axis, the y-axis and the z-axis are defined in the same manner as in FIG. 1.

The electronic component 1C is made different from the electronic component 1B by shifting the extension 16B-2 of the flange 16B in the y-axis direction to the center of the flange 16B and by shifting the extension 18B-2 of the flange 18B in the y-axis direction to the center of the flange 18B. There is no other difference between the electronic component 1C and the electronic component 1B, and the other parts of the electronic component 1C are not described here. In FIG. 5, the flanges of the electronic component 1C are denoted by 16C and 18C, and the extensions of the flanges 16C and 18C are denoted by 16C-2 and 18C-2. In FIG. 5, the same parts and members as provided in the electronic component 1A are denoted by the same reference marks as shown in FIG. 1. The electronic component 1C of the above-described structure has the same advantageous effects as described in connection with the first embodiment.

### Fourth Embodiment

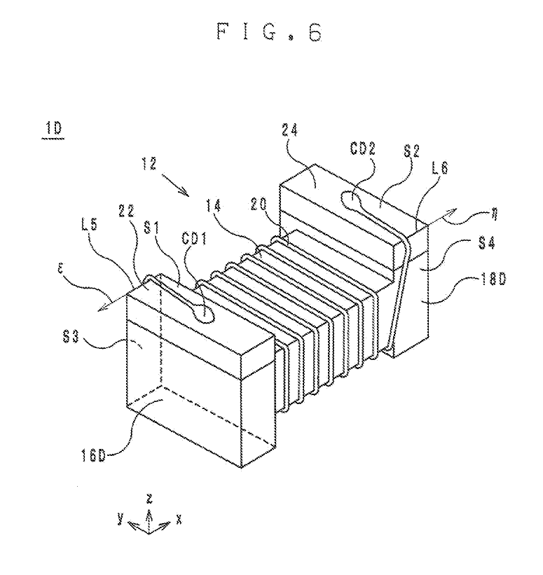

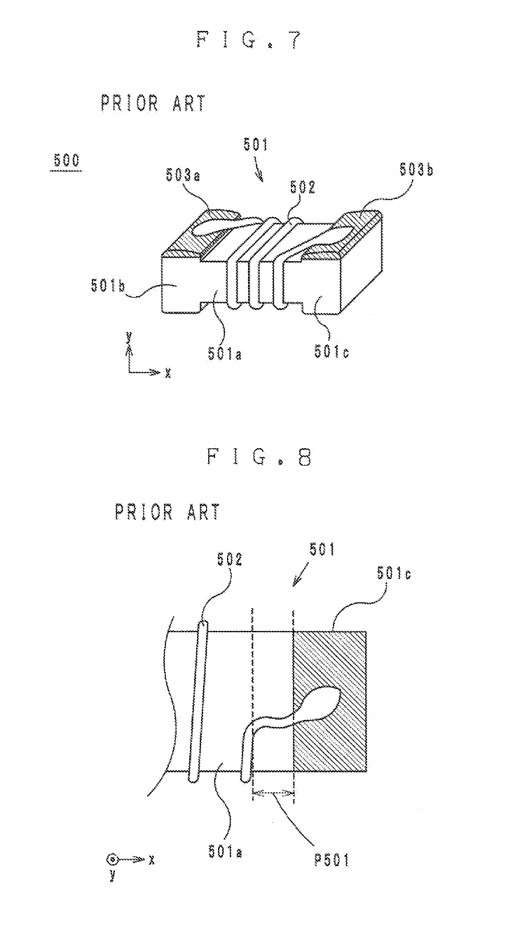

The structure of an electronic component 1D according to a fourth embodiment is described with reference to the accompanying drawings. FIG. 6 is a perspective view of the electronic component 1D according to the fourth embodiment. In FIG. 6, the x-axis, the y-axis and the z-axis are defined in the same manner as in FIG. 1.

The electronic component 1D is different from the electronic component 1A in the shapes of the flanges and in the positions of the connection points between the wire 20 and the external electrode 22 and between the wire 20 and the external electrode 24. There is no other difference between the electronic component 1D and the electronic component 1A, and the other parts of the electronic component 1D are not described here. The flanges of the electronic component 1D are denoted by 16D and 18D. In FIG. 6, the same parts and members as provided in the electronic component 1A are denoted by the same reference marks as shown in FIG. 1.

As shown in FIG. 6, the flange 16D is a rectangular parallelepiped, and protrudes from the winding base 14 in both the positive and the negative z-axis directions and in the negative y-axis direction. A surface at the positive y-axis side of the flange 16D (first adjoining surface) is located on the same level with the surface at the positive y-axis side of the winding base 14. In the following, the surface at the positive y-axis side of the flange 16D is referred to as a side surface S3.

As shown in FIG. 6, the flange 18D is a rectangular parallelepiped, and protrudes from the winding base 14 in both the positive and the negative z-axis directions and in the positive y-axis direction. A surface at the negative y-axis side of the flange 18D (second adjoining surface) is located on the same level with the surface at the negative y-axis side of the winding base 14. In the following, the surface at the negative y-axis side of the flange 18D is referred to as a side surface S4.

The wire 20 is connected to the external electrodes 22 and 24 at connection points CD1 and CD2, respectively, in substantially the center of the flange 16D and in substantially the center of the flange 18D with respect to the y-axis direction.

In the electronic component 1D, an end portion of the wire 20 is drawn from the surface at the positive y-axis side of the winding base 14 to the side surface Si (side surface located at the end in the first direction) of the flange 16D through the side surface S3 of the flange 16D, and the wire 20 is connected to the external electrode 22 on the side surface S1. In a plan view from the z-axis direction, an outer edge L5 of the flange 16D that crosses the wire 20 (first outer edge) is parallel to the x-axis, that is, the vector e of the outer edge L5 has only a component in the x-axis direction.

In the electronic component 1D, the other end portion of the wire 20 is drawn from the surface at the negative y-axis side of the winding base 14 to the side surface S2 (side surface located at the end in the first direction) of the flange 18D through the side surface S4 of the flange 18D, and the wire 20 is connected to the external electrode 24 on the side surface S2. In a plan view from the z-axis direction, an outer edge L6 of the flange 18D that crosses the wire 20 (first outer edge), that is, the vector e of the outer edge L6 has only a component in the x-axis direction.

In the electronic component 1D, it is not necessary to bend the wire 20 in the x-axis direction, and the electronic component 1D does not have such a problem as in the chip coil 500 that winding base 501a has wire-unwound portions P501. Hence, in the electronic component 1D, the wire 20 can be wound around the winding base 14 from one end to the other end, and it is possible to obtain a desired inductance value. The flanges 16D and 18D are of a simpler shape than the flanges 16A and 18A of the electronic component 1A.

In the electronic component 1D, further, the connection point CD1 between the wire 20 and the external electrode 22 and the connection point CD2 between the wire 20 and the external electrode 24 are substantially in the center of the flange 16D and substantially in the center of the flange 18D, respectively, with respect to the y-axis direction. Therefore, at the time of thermocompression bonding of the wire 20 to the external electrode 22 and to the external electrode 24, even if the ends of the wire 20 are disposed out of the intended positions, the wire 20 can be certainly thermocompression-bonded to the external electrodes 22 and 24.

### Other Embodiments

Electronic components according to the present disclosure are not limited to the electronic components 1A to 1D according to the embodiments above, and various changes and modifications are possible within the scope of the disclosure. For example, the connection points between the wire 20 and the external electrode 22 and between the wire 20 and the external electrode 24 do not need to be located on the mounting surface. Also, it is possible to combine the structure according to one of the embodiments with the structure according to another of the embodiments.

In the electronic component 1A, the external electrode 22 is provided on the side surface S1. However, the external electrode 22 may be provided on any other side surface of the flange 16A. Similarly, although the external electrode 24 is provided on the side surface S2, the external electrode 24 may be provided on any other side surface of the flange 18A. Also, each of the external electrodes 22 and 24 may be formed to cover two or more side surfaces. The same also applies to the external electrodes 22 and 24 of the electronic components 1B to 1D.

In the electronic component 1A, the flange 16A protrudes from the winding base 14 in all of the directions perpendicular to the x-axis direction. However, the flange 16A may be of a shape protruding from the winding base 14 at least in the positive z-direction. It is only necessary that the wire 20 runs from the winding base 14 up to the side surface S1 that is the surface located at the positive z-axis end of the flange 16A. In this regard, it is only necessary that the vector a of the outer edge L1 of the flange 16A that crosses the wire 20 when viewed from the positive z-axis direction, as shown by FIG. 2, has a component ax in the x-axis direction. The same also applies to the electronic components 1B and 1C.

Further, each of the electronic components 1A to 1D may have only one flange 16A or 18A.

Although the present disclosure has been described in connection with the preferred embodiments above, it is to be noted that various changes and modifications may be obvious to persons skilled in the art. Such changes and modifications are to be understood as being within the scope of the disclosure.

What is claimed is:

1. An electronic component comprising:
a core including a winding base extending in an axial direction, and a first flange located at an end of the winding base in the axial direction and having at least one first protruded side surface, which is protruded from the winding base, at least at an end in a first direction, which is one of perpendicular directions that are perpendicular to the axial direction;
a wire wound around the winding base;
a first external electrode connected to the wire and provided on a side surface of the first flange located at an end in one of the perpendicular directions; and
a first outer edge of the first flange crossing the wire when viewed from the first direction having a vector, the vector having a component in the axial direction.

2. The electronic component according to claim 1, further comprising a second external electrode connected to the wire,
wherein the core further comprises a second flange located at another end of the winding base in the axial direction and having at least one second protruded side surface, which is protruded from the winding base, at least at an end in a second direction, which is one of the perpendicular directions;
wherein the second external electrode is provided on a side surface of the second flange located at an end in one of the perpendicular directions; and
wherein a second outer edge of the second flange that crosses the wire when viewed from the second direction has a vector having a component in the axial direction.

3. The electronic component according to claim 1, wherein in a plan view from the first direction, the first outer edge is located between both ends of the first flange in a direction perpendicular to the axial direction.

4. The electronic component according to claim 1, wherein a first adjoining surface that is a side surface of the first flange adjoining the first protruded side surface and that intersects with the first protruded side surface at the first outer edge is on a same level with a surface of the winding base adjoining the first adjoining surface.

5. The electronic component according to claim 1, wherein a first connection point where the wire is connected to the first external electrode on the first flange is located on a side surface, in a center portion.
